(19) United States
(12) Patent Application Publication
(10) Pub. No.: US 2003/0003428 A1
(43) Pub. Date: Jan. 2, 2003

(54) Device and a computer program for supporting reading of a text

(76) Inventor: Tomas Dalstrom, Stockholm (SE)

Correspondence Address: Swidler Berlin Shereff Friedman, Suite 300, 3000 K Street NW, Washington, DC, 20007, US

(21) Appl. No.: 10/169,165

(22) PCT Filed: Jan. 22, 2001
(86) PCT No.: PCT/SE01/00110

(30) Foreign Application Priority Data
Jan. 20, 2000 (SE) 0000168-5
Mar. 23, 2000 (SE) 0001034-8

(51) Int. Cl. G09B 17/00

(52) U.S. Cl. 434/178

(57) ABSTRACT

The invention refers to a device and a computer program for supporting reading of a text containing a number of words. The device includes first means arranged to provide said text, an electronic display member (1) arranged to display the text, and processing unit (2, 3, 4, 5) arranged to control the displaying of the text. The processing unit includes identification means arranged to identify some of said words, which fulfil at least one criterion. The processing unit is arranged to provide displaying of said text on the display member (1) without the identified words.

### THE BACKGROUND OF THE INVENTION AND PRIOR ART

The present invention refers to a device for supporting reading of a text, which contains a number of words, wherein the device includes an electronic display member arranged to display successively said text to a user, and a processing unit arranged to control the displaying of the text. The invention also refers to a computer program for supporting reading of a text, wherein the computer program is storable in a memory unit and arranged to control the displaying of a text containing a number of words on an electronic display member in such a way that said text is displayed successively on the display member.

Computers and Internet become an increasing and deeper significance in the society. The need of reading information from a screen is therefore of an increasing importance. Internet and other computer applications are, and will be during a long time, text-based media. This means that the reading also in the future is an important function for individuals, companies and the society.

In the course of time new technologies have helped us to receive knowledge in a much quicker, better and more intelligent manner. The alphabet, which was constructed four thousand years ago, is an important milestone as well as the art of printing, which was invented in Europe year 1455 and in China 1040.

People are learning to read by reading each word and combining them with each other. This method is used by most people during the whole life. A small number of people absorbs, and uses, the quick reading methods which are offered on the market. For most people it means that the reading process has not changed since the days of the art of printing and Gutenberg. It is generally known that people only use a fraction of the brain, this is valid also during reading. Research results show that 60-85 characters/second (c/s) is the reading speed which is most suitable for the brain. At this speed, the concentration is at the highest, the motivation on top and the understanding as best. However, there are only few people, who reach this result. A normal reader reading from a paper will cope with about 30 c/s, if the text is easy to read. If the text is difficult to understand the result is about 13 c/s. If the same text is available on a screen, the reading speed is decreasing with approximately 25%. This means about 23 c/s and 10 c/s, respectively. The explanation to the fact that we read more slowly from a screen is for instance that the screen is located horizontally, has a lower contrast and that the eye is blinking more frequently. There are people who means that human beings without university education are reading further 25%. slower and that most human beings does not develop their reading after the age of 12 year. Add the fact that about 5% of the population suffer from dyslexia and that 15% are considered to have reading problems. Slow reading is in other words a personal loss and an economic loss from a company and community point of view, for which there is a reason to try to find solutions. The one who reads slowly becomes tired, which in turn results in a reduced concentration and motivation.

When reading from a paper, it is known to utilise some sort of aiding means, for instance a finger or a pencil, wherein the pencil advantageously is guided along the text rows somewhat ahead of the word to be read for the moment. Research has disclosed that such a reading technique enables a significant increase of the reading speed with a maintained understanding of the reading.

Different types of read aiding means are also known from the patent literature. For instance, U.S. Pat. No. 3,872,372 discloses a device for facilitating reading of a text from a TV-screen. Thereby, the TV-screen is covered by a raster in such way that the whole of the text disappears and only the word or words to be read are visible to the user in a window. The window may move at a desired speed over the screen and in such a way the reader is forced to follow the movements of the window with the eyes. Thereby, the window with the displayed words or word appears to move at discrete steps rather than with a uniform, continuous movement in order to display all words at each moment. However, this known device ought to have certain drawbacks since only the words which are read for the moment, are visible. Consequently, it is difficult for the user to have any overview of the text and know where in the text he is positioned. U.S. Pat. No. 3,721,021 discloses a mechanical device including a ruler being moveable vertically over a text. U.S. Pat. No. 5,592,143 discloses a device for supporting reading by means of a pulsating sound. The frequency of the sound pulses generated are variable in order to improve the reading learning. U.S. Pat. No. 3,698,103 discloses another mechanical device for increasing the reading speed of a user. The mechanical device includes a plurality of camcontrolled diaphragm members sequentially showing areas of a text.

### SUMMARY OF THE INVENTION

The object of the present invention is to provide a device or a tool, by means of which reading of a text from a display member can be facilitated and more efficient, in particular by means of which the reading speed can be raised with a substantially maintained understanding of the reading.

This object is obtained by the device initially defined, which is characterised in that the processing unit includes identification means, arranged to identify some of said words, which fulfill at least one criterion, and that the processing unit is arranged to provide displaying of said text on the display member without the identified words.

The inventor has realised that it is not necessary to read all words in a text in order to understand the text. This understanding is supported by research results, and certain researchers state that it is possible to remove about 70-90% of the words in a text without reducing the possibilities of understanding the text and without reducing the capability of remember the content. The explanation thereto is, for instance, that the brain continuously tries to understand the meaning of the text concurrently with reading of the text. It is usual that the brain guesses, which word or words follow after certain word or combinations of words. The fact that 45%. of a text consists of the fifty most used words of the language, and that the language follows a certain syntax, make the readerbrain normally able to understand the meaning of the text without reading each word. This means that it is possible to remove a part of the text and at the same time maintain the understanding of the reading. In accordance with these thoughts, the invention thus proposes a device by means of which superfluous words may be removed from a text. By displaying such a text without superfluous words on a display member, it is possible for a reader to quicker and in a more efficient manner read and understand the text. It is to be noted here that the identification of superfluous words and the displaying of the text without the superfluous words can be made by a reader of the text, wherein the text has been delivered in a original version. However, it is also possible to utilise the device according to the invention in connection with the creation of the text and at this occasion to create a text without any superfluous words, which thereafter may be distributed to different readers. For instance, such a text without superfluous words may be distributed via different data communication systems, such as Internet, Intranet, CD-ROM, mobile phones, for instance so called WAP-phones, E-mail, digital TV, etc. Of course, the text may also be distributed via such data communications system in an original version and thereafter the reader may make the desired adaptation of the text with his own equipment. Thereby, possibilities are also created to the reader to make individual changes of the text, i.e. to remove the words, which are superfluous to the individual reader.

According to an embodiment of the invention, said means are arranged to identify said some of the words in an automatic manner. Such an automatic identification of superfluous words may be made in a easy manner by means of the computer applications which are intended to provide the text and display it on the displaying member.

According to a further embodiment of the invention, said means includes a list, wherein said criterion involves that the word concerned is included in the list. Thereby, the device may advantageously include a memory unit, which is arranged to store the list and at the same time store the text with the identified words. However, the memory unit may also be arranged to store the text without the identified words. Such a list may be individual or general.

According to a further embodiment of the invention, said criterion involves fulfilling of at least one grammatical parameter of the word concerned. Thereby, said criterion may involve that the word concerned is a preposition, a pronoun, a conjunction or any similar word, which has a relatively small significance for the content of the text. Furthermore, the word concerned may include grammatical refinement and more stylistic constructions.

According to a further embodiment of the invention, the device includes a further display member, which is provided in the proximity of the first display member and arranged to permit simultaneous displaying of said part of the text with the identified words. In certain cases, it is necessary for the reader to see the original text, for instance for checking if it says “is to” or “should” in a sentence. The reader may ask for the original text on the further display member. However, it is also possible to obtain the further display member by dividing a screen in two text fields. In one of the text fields, there is the shortened version and in the other text field the original text. These two texts are advantageously synchronised so that corresponding words have the same position on the two display members. Thereby, it is easy to orient oneself in the two texts.

According to a further embodiment of the invention, the processing unit includes second means arranged to display a marking, which marks at least one character of said part of the text on the display member, wherein said second means are arranged to move the marking in an automatic manner on the displayed part of the text in order to control the reading of the text. Such a marking, which moves automatically over the text facilitates to a reader to follow the text with the eyes. The reader may thereby to a higher extent concentrate on the content of the text and does not need to make any effort to orient himself in the text. By such a marking, in combination with the omission of superfluous words, a significant increase of the reading speed ought to be possible to obtain.

According to an embodiment of the invention, said second means are arranged to control the movement of the marking in such a way that the movement appears as a substantially continuous movement along a preferably horizontal portion of the displayed part of the text, or in other words, along a row of the displayed part of the text. By such a uniform movement of the marking, the eyes of the reader may easily follow the text, i.e. the marking moves without jumping from one character to another by a continuous speed over a text portion, for instance a text row, before the marking is jumping to the next row.

According to a further embodiment of the invention, a regulating member is provided, by means of which the speed at which the marking moves over the text is controllable. By such a regulating member, an. individual adaptation of the moving speed of the marking is obtained. The reader may also adapt the speed to different degrees of difficulty of the text which is read for the moment.

According to a further embodiment of the invention, said second means are arranged to change from displaying said part of the text to displaying a successive part of the text when the marking is located in the proximity of the end of said part, wherein the marking is arranged to move continuously in the text from said part to said successive part. In such a way an automatic scrolling of the text is obtained, and the user may in an easy manner find the proper position in the text for continuing reading after a page break, i.e. the marking will be located where the user is to start reading after a page break.

According to a further embodiment of the invention, the marking includes an area, which is displayed in the display member and which is located ahead of said marked character, wherein said area hides substantially completely the part of the text located within the area. The marking thereby forms a forward limit of the part of the text which is displayed on the display member. Thereby, the marking may be arranged to display the area as a substantially empty surface. Such an empty of substantially blank surface without any signs or patterns does not guide away the eyes, but the reader may concentrate on the text. Advantageously, the marking may be arranged to permit selection of colour of the substantially empty surface.

According to a further embodiment of the invention, an initiating member is arranged to permit a user to start and stop, respectively, the movement of the marking. In such a way, it is easy for the reader to take a short break in reading, for instance, if there is a need therefore. Thereby, the area may advantageously be transparent so that the hidden text is at least legible.

According to a further embodiment of the invention, said second means are arranged to display the marking in such a manner that the marking appears as a substantially fixed marking. It is not tiring to keep the eyes on such a steady, fixed marking moving along the text.

According to a further embodiment of the invention, the text is arranged in a conventional manner per se in rows having a number of words in each row, wherein said second means are arranged to control the movement of the marking from one row to another.

According to a further embodiment of the invention, the processing unit includes second means arranged to feed successively said part of the text on the display member in such a way that a forward limit of said part of the text is moved forwardly and that an increasing part of the text is disclosed, wherein said second means are arranged to move said limit in an automatic manner in order to control the reading of the text.

According to a further embodiment of the invention, said processing unit may be comprised by a computer, for instance a PC, digital television, pager, cellular telephones, for instance so called WAP-telephones, radio or an electronic book. Said first means also includes software, for instance in the form of any word processing program.

According to a further embodiment of the invention, the processing unit includes third means arranged to permit storing of a portion of the text in a memory member, wherein these third means include an actuating member designed to initiate storing by the reader defining a start position and an end position for said portion. In such a way it is possible to create a directory including text portions being interesting to the reader.

The object is also obtained by the computer program initially defined, which is characterised in that it is arranged to identify some of said words, which fulfill at least one criterion, and to provide displaying of said text on the display number without the identified words.

### BRIEF DESCRIPTION OF THE DRAWINGS

The present invention is now to be explained more closely by means of embodiments, described as examples, and with reference to the drawings attached hereto.

FIG. 1 discloses schematically a device for supporting reading according to an embodiment of the invention.

FIG. 2 discloses schematically a device for supporting reading according to another embodiment of the invention.

FIG. 3 discloses schematically a device for supporting reading according a further embodiment of the invention.

### DETAILED DESCRIPTION OF DIFFERENT EMBODIMENTS OF THE INVENTION

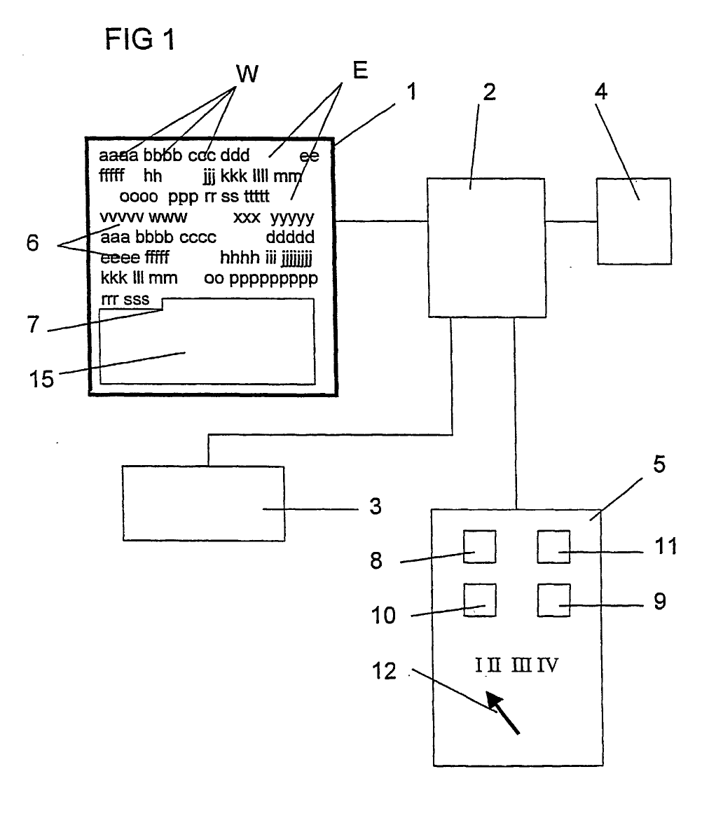

FIG. 1 discloses schematically how a reading support device according to the invention may be designed. The device includes an electronic display member in the form of a screen 1, for instance of the type cathode-ray tubes or a so called LCD-screen, i.e. a screen having liquid crystals. The screen 1 is connected to a processor 2, which receives commands from an input unit 3, which may include a keyboard and/or a mouse. Furthermore, the processor 2 co-acts with a memory member 4 including an internal memory and a memory in the form of a hard disc. The components 2, 3, 4 disclosed form together a processing unit and parts of a conventional computer. In addition, the device includes a control unit 5, which is to be described more closely below.

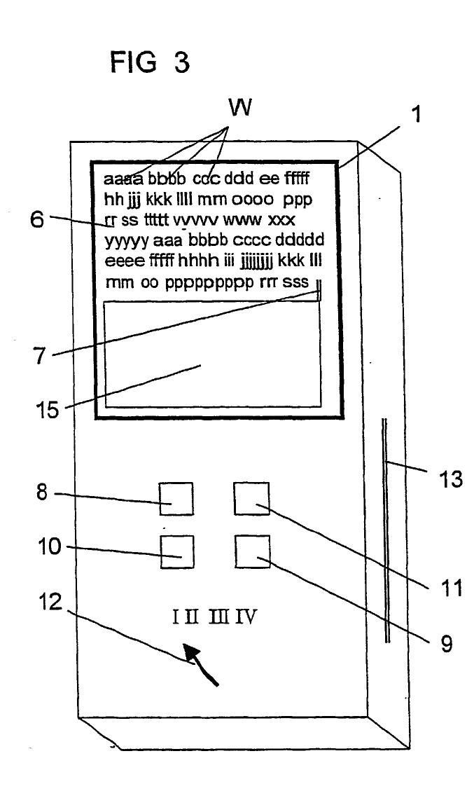

The reading support device is arranged to enable displaying of a text on the screen 1. The text includes in a normal way a number of characters, which form words W in the text, which are arranged in substantially horizontal rows 6. In a usual manner, a part of a longer text is disclosed successively or in a running manner on the screen 1, i.e. at each moment a part of the text is displayed. The text is digitally stored in the memory member 4, or any other memory member, for instance a database, a diskette or a CD-ROM, and which is successively disclosed on the screen 1 by means of the processor 2. The reading support device includes identification means in the form of a computer program, which is arranged to be processed or executed by the processor 2. The identification means are arranged to identify a part of the words W in the text, which fulfills at least one criterion. The processor 2 is arranged to provide displaying of said part of the text on the display member without the identified words. However, the text, which is displayed on the screen 1, may include information about which words have been removed, for instance in the form of empty portions E instead of the identified words, as is disclosed in FIG. 1. The identified words may also be marked by means of any symbol, for instance a dash. The empty portions E may be blank or shaded. However, it is also possible to compress the text, i.e. to pull together the remaining words without in any way indicate to the reader that words have been removed, as is exemplified in FIG. 3. The identification means are arranged to identify said part of the words in an automatic manner by means of the computer program and the processor 2.

The processor 2 may include a list, which is stored in the memory member 4 and which includes the words which are to be removed from the displayed text, i.e. said criterion involves that the word concerned are included in the list. The memory member 4 may be arranged to store the text without the identified words ox with the identified words, wherein the processor 2 control the identification means in such a way that the identified words, for instance, are hidden in connection with the displaying of the text. Said criterion may furthermore include fulfilling of at least some grammatically parameter of the word concerned, for instance that the word concerned is a preposition and/or a conjunction, or any other grammatically word type which permits understanding of a text even if the word concerned has been removed.

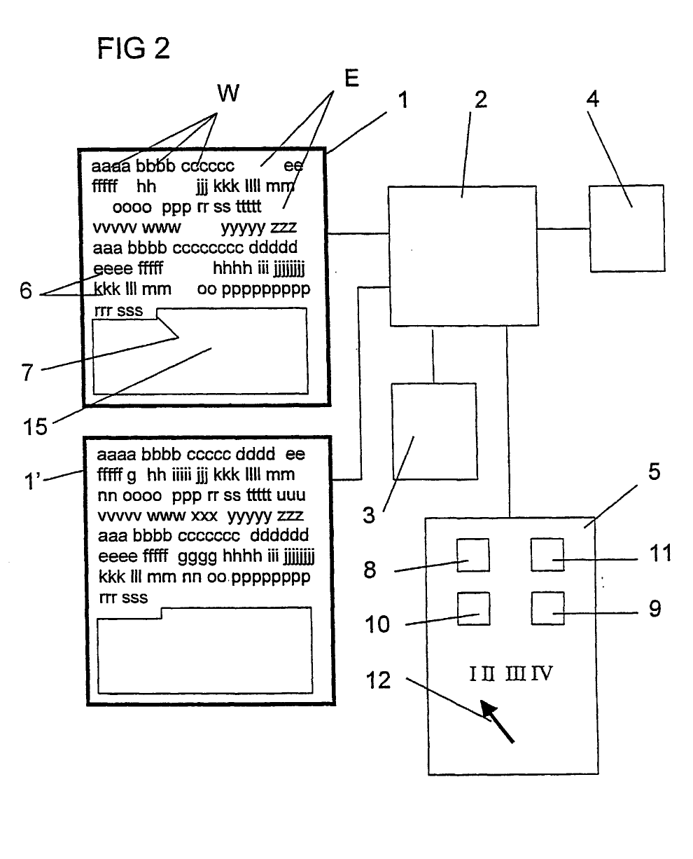

FIG. 2 discloses an embodiment of the device with a further display member in the form of a screen 1′, which is provided in the proximity of the screen 1 and which enables simultaneous displaying of the text with the identified words. In such a way, the complete text may be studied more in detail if there is such a need, for instance in connection with more complicated text portions.

The reading support device may in addition as a further possibility include means arranged to display a marking on the screen 1. FIG. 1 discloses such a marking 7 in the form of a line, which extends substantially vertically, i.e. across a row 6 of the part of the text displayed on the screen 1. The marking 7 is arranged to move along the text, i.e. with a movement extending substantially in parallel with a row 6 in order to control the reading of the text.

The marking 7 is intended to move automatically, i.e. when the marking 7 has been initiated it moves with a substantially uniform speed over the text which is stationary during a time period. When the marking 7 has arrived at the end of the part of the text displayed on the screen 1, the text is moved so that an at least partly other part of the text is disclosed on the screen 1. The marking 7 will thereby move on the screen 1, for instance from the lower right corner to the upper left corner, but maintain its position in relation to the text.

The movement of the marking 7 may be controlled by the control unit 5, which includes an initiating member 8, which is designed as a key and arranged to permit a user to start and stop, respectively, the movement of the marking 7 by a simple pushing. Furthermore, the control unit 5 includes a regulating member 9, 10, by which the moving speed of the marking 7 may be controlled. The regulating member 9, 10 includes a first key 9, which is indicated by a “+”-sign and by which the speed of the marking may be increased by pushing the key 9, and a second key 10, which is marked with a “−”-sign and by which the speed of the marking 7 may be decreased by pushing the key 10.

Furthermore, the control unit 5 includes an actuating member in the form of a key 11 and a function selector 12, by which different functions may be obtained. For instance, by the function I storing of a portion of the text may be selected, which portion may be stored separately in the memory member 4 or any other memory unit. The storing may be initiated when the marking 7 moves over the text by a simple pushing of the key 11 and stopped by a successive pushing of the key 11 when the marking 7 has moved over a desired portion. The purpose of this function I is to make the stored portion easily accessible to a user and, for instance, to enable them to be displayed once again by a simple pushing of the key 11 when the marking 7 does not move over the text, i.e. when the reading support device is not activated. It is to be noted that the activation of the portions stored in the memory member 4 also can take place in other manners. By such a storing function, a user may collect different text portions for an easy putting together of a lecture or a concept to a written report, for instance.

If the function selector 12 is positioned in the position II, a time measurement may be initiated by the key 11. By such a time measurement, the user may read a part of the text displayed on the screen 1 and thereafter once again push the key 11 in order to stop the time measurement. The reading support device is thereby arranged to calculate the reading speed, i.e. the number of words per time unit, whereafter the user may adjust the reading support device in such a way that the marking 7 moves by this speed. This function II is advantageous when the user reads texts of different degree of difficulty, since a difficult text normally is to be read at a lower reading speed than an easier text. Advantageously, the screen 1 may be arranged to display the measured reading speed and also the reading speed by which the marking 7 moves. The reading support device may in addition be arranged to store individual reading speeds and to adjust automatically these speeds when a certain user wishes to read a text. Also other individual wishes may be adjusted automatically for each user, for instance, length of the break after a command, full stop, new row, scrolling, and parameters such as character size, number of characters per row, number of words per row, margin for notes and comments etc.

By the function selector 12 in the position III, a function is obtained, which enables a selective reading to a user, i.e. the user may skim through a text. This may for instance be obtained by moving the marking 7 vertically downwardly on the screen 1 or in such a way that the marking 7 jumps between headlines, intermediate headlines, preambles or captions. By the key 11 such a selective reading may be initiated and interrupted. Furthermore, the speed of the marking 7 may be increased or decreased in case of such a selective reading by means of the keys 9 and 10.

By the function selector 12 in the position IV, the above described displaying of the text on the screen 1 without the identified words is obtained. It is to be noted that the function selector 12 only is disclosed schematically and that it ought to be arranged, for instance, to permit more than one function simultaneously, for instance the functions II and IV.

The means mentioned above, which are arranged to identify words and display the marking 7 and to provide its movement, may be realised in form of a computer program, which is stored in the memory member 4 in a conventional manner. In the same way, the means by which portions of the text may be stored in the memory member 4, may be realised in the form of a computer program stored in the memory member 4.

The means mentioned above are thus arranged to move the marking 7 in such a way that its movement appears as a substantially continuous, uniform movement along the text. It is advantageous that the marking 7 does not jump from character to character or possibly from word to word, which would be tiring to a user when he reads the text. By a continuous movement at high reading speeds, a possibility to read word pictures, i.e. several words at the time, is obtained. Such reading corresponds to the manner in which the eye/brain perceives a text. Furthermore, the means are arranged to display the marking 7 in such a way that it appears as a substantially fixed marking, i.e. that the marking 7 does not twinkle.

FIG. 3 discloses a second embodiment of the reading support device. In this case, the device is designed as an electronic book with a screen 1 and the keys 8, 9, 10, 11 and 12, which correspond to those provided in the device in the first embodiment disclosed in FIG. 1. Also the device in FIG. 3 thus includes a processor (not disclosed in FIG. 3) and a memory member including an aperture 13 for receiving an information carrier, for instance Internet, a CD-rom etc. In other respects, the reading support device disclosed in FIG. 3 functions in the same way as the one disclosed in FIG. 1.

FIGS. 1-3 disclose the marking in the form of a forward limit 7 of the displayed part of the text. The limit 7 is moved successively and substantially continuously forwardly in such a way that an increasing part of the text is displayed on the screen 1. According to this embodiment, the marking may also include an area 15, which is located ahead of the limit 7 and which advantageously may extend to the end of the screen 1. Thereby, the part of the text located ahead of the limit 7 and thus inside the area 15 may be substantially completely hidden to a user. Possibly, the hidden area 15 may be made legible during a break in the reading of the text. The area 15 may be displayed as a substantially empty surface. It is also possible, by means of the control unit 5, to select a to the user suitable colour of the area 15 or the substantially empty surface. It is to be noted that the limit 7 may be visible on the screen as, for instance, a vertical line. The limit 7 may also be invisible in the sense that it is not marked but merely forms the transition to the area 15.

The marking 7 may be designed in different manners, for instance as a dot located beneath a character in the text, as a frame or a window surrounding a number of characters in the text and extending in parallel with a row 6 of the text. Furthermore, the marking 7 may be designed in such a way that the characters to be marked are displayed by bold type. The other characters in the text have here, as an example, been displayed by italicised type. The marking 7 may also include a shadowing of an area within which the characters to be marked are located. This shadowing may be performed in a grey tone scale or in any suitable colour. Of course it is essential that the shadowing is so weak that the text located therebehind is clearly legible.

It is to be noted that the marking 7 may be designed in many further manners, for instance it may include a line located above the characters to be marked. The marking 7 may also be designed as a filled circle moving along the text.

The invention is applicable to all types of texts, which are displayed on a screen, for instance texts in word-processing programs/, texts received via E-mail, Internet or any other network, text-TV, digital TV, radio, pagers, palm-computers, cellular phones, etc. The invention may for instance be realised as a computer program, which is adapted to available word-processing programs and other types of programs supporting text reproduction. The invention may thus be utilised for reading of information, commercial advertising, novels, articles, correspondence, E-mail and the like. The invention is also advantageous in connection with for instance proof-reading of drafts to different writs.

The invention is not limited to the embodiments described but may be varied and modified within the scope of the following claims.

The control unit 5 disclosed may be a part of a computer or formed by a program stored in a computer, wherein the functions of the keys 8, 9, 10, 11 and 12 may be realised by means of keys of a keyboard of standard type and/or a mouse. It is also possible to provide the reading support device with voice control, wherein the keys 8, 9, 10, 11 and 12 may be replaced or supplemented by voice commands.

The invention may advantageously include further functions, which may be implemented in the computer or a similar device including the reading support device. There may, for instance, be a routine, which in an automatic manner replaces characters, which in the context are incomprehensible, but which may arise in connection with converting between different formats. The reading support device may also include a dictionary of synonyms, which offers a user a synonym to a word in the text, or a dictionary, which translates from one language to another.

Furthermore, the reading support device may be provided with a search function, wherein the marking may be placed, for instance, one or two sentences ahead of a defined search word.

By means of the control unit 5, the time length of breaks after different punctuation marks, change of row, scrolling may be controlled.

1. A device for supporting reading of a test, which contains a number of words, wherein the device includes first means arranged to provide said text, an electronic display member arranged to display successively said text to a user, and a processing unit (2, 3, 4) arranged to control the displaying of the text, charaterised in that the processing unit (2, 3, 4) includes identification means, arranged to identify some of said words, which fulfill at least one criterion, and that the processing unit (2, 3, 4) is arranged to provide displaying of said text on the display member without the identified words.

2. A device according to claim 1, characterised in that said means are arranged to identify said some of said words in an automatic manner.

3. A device according to any one of claims 1 and 2, characterised in that said means include a list and that said criterion involves that the word concerned is included in the list.

4. A device according to claim 3, characterised in that the device includes a memory unit (4) arranged to store the list.

5. A device according to claim 4, characterised in that the memory unit (4) is arranged to store the text without the identified words.

6. A device according to any one of the preceding claims, characterised in that the said criterion involves fulfilling of at least one gramnatical parameter of the word concerned.

7. A device according to claim 6, characterised in that said criterion involves the word concerned being a preposition.

8. A device according to any one of the preceding claims, characterised in that the device includes a further display member (1′), which is provided in the proximity of the first display member (1) and arranged to permit simultaneous displaying of said part of the text with the identified words.

9. A device according to any one of the preceding claims, characterised in that the processing unit (2, 3, 4, 5) includes second means, arranged to display a marking (7), which marks at least one character of said part of the text on said display member (1, 1′), wherein said second means are arranged to move the marking (7) in an automatic manner on the displayed part of the text in order to control the reading of the text.

10. A device according to claim 9, characterised in that said second means (2, 5) are arranged to control the movement of the marking in such a manner that the movement appears as a substantially continuous movement at least along a portion of the text.

11. A device according to any one of claims 9 and 10, characterised in that a regulating member (9, 10), by means of which the speed by which the marking (7) moves over the text is controllable.

12. A device according to any one claims 9 to 11, characterised in that said second means (2, 5) are arranged to change from displaying said part of the text to a successive part of the text when the marking (7) has arrived to the end of said part, wherein the marking (7) is arranged to move continuously in the text from said part to said successive part.

13. A device according to any one of claims 9 to 12, characterised in that the marking (7) includes an area (15), which is displayed on said display member (1) and is located ahead of said marked character, wherein said area (15) hides substantially completely the part of the text located within the area.

14. A device according to claim 13, characterised in that the marking (7) is arranged to display the area (15) as a substantially empty surface.

15. A device according to claim 14, characterised in that the marking (7) is arranged to permit selection of colour of the substantially empty surface.

16. A device according to any one of claims 9 to 15, characterised by an initiating member (8), which is arranged to permit a user to start and stop, respectively, the movement of said marking means (7).

17. A device according to any one of claims 9 to 16, characterised in that said second means (2, 5) are arranged to display the marking (7) in such a manner that the marking (7) appears as a substantially fixed marking.

18. A device according to any one of claims 9 to 17, characterised in that the text is provided in a conventional manner per se in rows (6) with a number of words in each row, wherein said second means (2, 5) are arranged to control the movement of the marking (7) from one row (6) to another row.

19. A device according to any one of claims 1 to 8, characterised in that the processing unit (2, 3, 4, 5) includes second means, arranged to feed successively said part of the text on the display member in such a way that a forward limit (7) of said part of the text is moved forwardly and that an increasing part of the text is displayed, and wherein said second means are arranged to move said limit (7) in an automatic manner in order to control the reading of the text.

20. A device according to any one of the preceding claims, characterised in that the processing unit (2, 3, 4) is included by a computer.

21. A device according to any one of the preceding claims, characterised in that the processing unit (2, 3, 4, 5) includes third means (2, 4), which are arranged to permit storing of a portion of the text in a memory member (4) and which includes a actuating member (11), which is designed to initiate storing by the reading defining a start position and an end position for said portion.

22. A computer program for supporting reading of a text, wherein the computer program is storable in a memory unit and arranged to control the displaying of a text containing a number of words on an electronic display member in such a manner that the text is displayed successively on the display member, characterised in that the program is arranged to identify some of said words, which fulfill at least one criterion, and to provide displaying of said text on the display member without the identified words.

23. A computer program according to claim 22, characterised in that the program is executable on a computer or the like.
